(19) United States
(12) Patent Application Publication
(10) Pub. No.: US 2009/0159256 A1
(43) Pub. Date: Jun. 25, 2009

(54) Vehicle air-conditioning system

(75) Inventor: Shoji Isoda, Tokyo (JP)

Correspondence Address: BUCHANAN, INGERSOLL & ROONEY PC, POST OFFICE BOX 1404, ALEXANDRIA, VA, 22313-1404, US

(73) Assignee: Mitsubishi Electric Corporation, Tokyo (JP)

(21) Appl. No.: 11/579,152

(22) PCT Filed: Mar. 17, 2006
(86) PCT No.: PCT/JP06/05387

§ 371 Date: Oct. 31, 2006

(51) Int. Cl. B60H 1/00; F25B 29/00

(52) U.S. Cl. 165/202; 165/61

(57) ABSTRACT

To propose a vehicle air-conditioning system capable of further reducing a temperature fluctuation of blowing-out air when temperature-conditioned air is supplied to an in-car space.

The vehicle air-conditioning system including a cooling apparatus 5 capable of changing an amount of withdrawn heat in a stepwise manner, heaters 6A, 6B, and 6C, each having different heat release capability, which constitutes a heating apparatus 6 capable of changing an amount of generated heat in a stepwise manner, and a control device 30 including a supplying amount of heat calculating portion 30A for calculating a supplying amount of heat to an in-car space 2 and an amount of generated and withdrawn heat setting portion 30B for setting amounts of withdrawn and generated heat of the cooling apparatus 5 and the heating apparatus 6 on the basis of the supplying amount of heat calculated by means of the supplying amount of heat calculating portion 30A.

### BACKGROUND OF THE INVENTION

1. Field of the Invention

The present invention relates to an air-conditioning system, and more particularly to an air-conditioning system for use in a vehicle.

2. Related Arts

A vehicle air-conditioning system utilizing a refrigeration cycle is already known (refer to, for example, patent documents, 1 and 2). In addition to the above, an automatic control for automatically adjusting the air-conditioning capability to conform an in-car temperature to a target temperature is recently performed. Although a controller (temperature controller) continuously requires the air-conditioning capability necessary for a deviation between the target temperature and the in-car temperature, the air-conditioning capability (cooling capability) cannot be changed in a manner other than a stepwise manner. This is because a compressor used for a cooling apparatus cannot perform operation other than that in a stepwise manner only at frequencies whose safety is confirmed in consideration of a problem of a resonance of a pipe arrangement system, or the like. Further, since stable circulation of lubricating oil commingled in a cooling medium circuit is also required for lubricating a rotating portion or a sliding portion of a cooling device, there is also a case that the operation of the compressor at a low frequency (for example, less than 30 Hz) cannot be performed, and it is thereby hard to correspond to a minute cooling load. In a case that a limitation on hardware of the air-conditioning system such as that described above exists, a method, in which operation of the compressor performed in a stepwise manner is used in combination with a turning-on rate control (turning-on time control) of a heater, has been heretofore adopted so as to generate the required air-conditioning capability in an approximate manner. As for the turning-on rate control of the heater, since an amount of generated heat can be steplessly controlled on an average per hour, the amount of generated heat is continuously controlled from a macroscopic point of view.

Patent Document 1: Japanese Unexamined Patent Application Publication No. 5-139142

Patent Document 2: Japanese Unexamined Patent Application Publication No. 2004-182201

### SUMMARY OF THE INVENTION

As described above, in a hitherto known vehicle air-conditioning system, since a required air-conditioning capability is generated in an approximate manner by means of operation of a compressor in a stepwise manner in combination with a turning-on rate control of a heater, there has been a problem that an in-car temperature fluctuates due to temperature fluctuation of blowing-out air caused by repetition of turning-on and turning-off operations of the heater. Further, there has been another problem that a sense of discomfort is felt by an occupant in the vicinity of a blowing-outlet due to the temperature fluctuation (temperature ripple) of the blowing-out wind.

The present invention is made to solve the above-described problems, and an object of the present invention is to propose a vehicle air-conditioning system capable of further reducing temperature fluctuation of blowing-out air compared to that of a hitherto known vehicle air-conditioning system when the temperature-conditioned air is supplied to a car interior.

The vehicle air-conditioning system with respect to the present invention is provided with a cooling apparatus capable of changing an amount of withdrawn heat in a stepwise manner, a heating apparatus capable of changing an amount of generated heat in a stepwise manner, and a control device that calculates an amount of heat to be supplied to a car interior on the basis of input information, and that sets a supplying amount of heat of the cooling apparatus and the heating apparatus on the basis of the calculated supplying amount of heat.

Incidentally, in general, the vehicle air-conditioning system further includes a target temperature setting device for setting a target value of the in-car temperature, and an in-car temperature detecting device for detecting the in-car temperature, and the control device calculates an amount of heat to be supplied to the car interior on the basis of input information including the set value of the target temperature setting device and the detected value of the in-car temperature detecting device.

Since the vehicle air-conditioning system with respect to the present invention determines air-conditioning capability by means of combining a cooling apparatus capable of changing an amount of withdrawn heat in a stepwise manner and a heating apparatus capable of changing an amount of generated heat in a stepwise manner, the same has an advantage to be able to suppress immediate fluctuation of in-car temperature by means of constantly supplying optimal amount of heat (an amount of withdrawn heat and an amount of generated heat) to a car interior, while suppressing immediate fluctuation of temperature of blowing-out air. Further, when amounts of variation of the cooling apparatus and the heating apparatus are minutely set in the stepwise manner, a slight adjustment of the air-conditioning capability also becomes available.

In addition, since the vehicle air-conditioning system with respect to the present invention is capable of supplying optimal amount of heat to the car interior without a turning-on rate control of a heater, there is also an advantage that the product life duration of the switches can also be improved upon reducing a frequency of turning-on and turning-off (ON/OFF) operation of the switches for driving the heaters to a large extent.

### BRIEF DESCRIPTION OF THE DRAWINGS

FIG. 1 is an explanatory view showing an example of a vehicle air-conditioning system with respect to an embodiment of the present invention, which is applied to a vehicle;

FIG. 2 is a refrigeration cycle construction view of a cooling apparatus constituting the vehicle air-conditioning system of FIG. 1;

FIG. 3 is a block diagram showing a construction of the vehicle air-conditioning system with respect to the embodiment of the present invention;

FIG. 4 is a flowchart showing contents of control of a control device constituting the vehicle air-conditioning system of FIG. 3; and

FIG. 5 is a timing chart showing an example of operation of the vehicle air-conditioning system of FIG. 3.

### BEST MODE FOR CARRYING OUT THE INVENTION

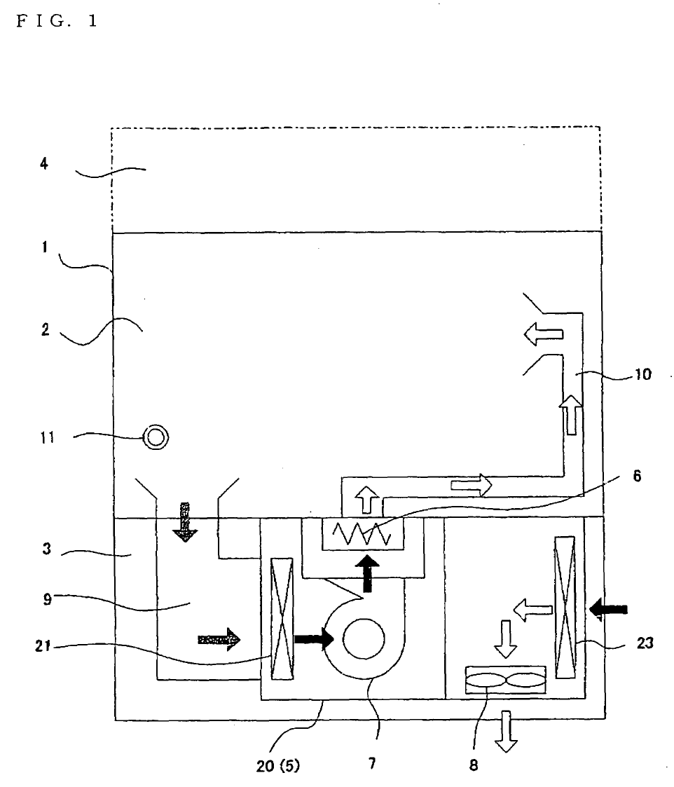

FIG. 1 is a construction view of a vehicle air-conditioning system with respect to the embodiment of the present invention. In FIG. 1, a vehicle 1 in which an air-conditioning system 20 is installed is configured to be composed of an in-car space (sometimes also called car interior, simply) 2, an under floor space 3, and an above-the-roof space 4. Incidentally, although a case that the air-conditioning system 20 is installed in the under floor space 3 is described in FIG. 1, there is also a case that the air-conditioning system 20 is installed in the above-the-roof space 4. The air-conditioning system 20 is provided with a cooling apparatus 5 that is capable of changing an amount of withdrawn heat in a stepwise manner, a heating apparatus 6 capable of changing an amount of generated heat in a stepwise manner, an indoor fan 7, and an outdoor fan 8.

Incidentally, a numeral 9 in FIG. 1 denotes a returning duct that returns air from the in-car space 2 to the air-conditioning system 20, and a numeral 10 denotes a blowing-out duct that sends air from the air-conditioning system 20 to the in-car space 2, respectively.

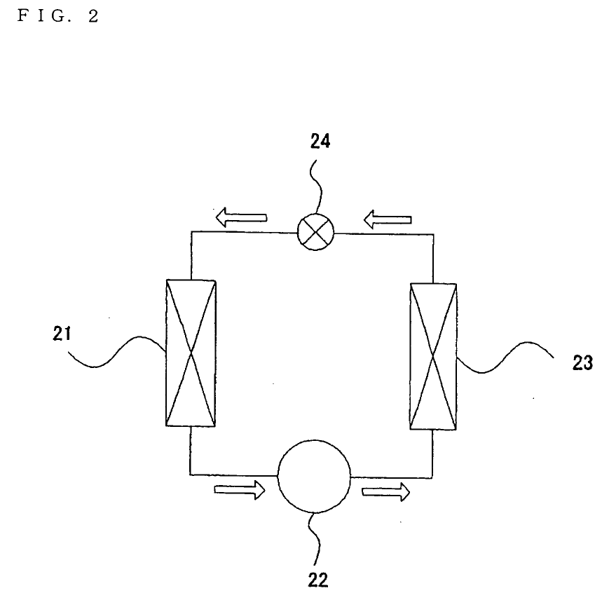

FIG. 2 is a construction view of the cooling apparatus 5, and a refrigeration cycle constituted by a cooling medium circuit in which an evaporator 21, a compressor 22, a condenser 23, and an expansion valve 24 are connected by a pipe arrangement in sequence, is constructed in the cooling apparatus 5. In addition, a temperature sensor 11 serving as an in-car temperature detecting device is provided in the in-car space 2.

Next, air-conditioning operation of the air-conditioning system 20 in the above-described vehicle 1 will be explained. The in-car air of the in-car space 2 is driven by means of the indoor fan 7 and taken in to the air-conditioning system 20 via a return duct 9. Further, the air is cooled by means of the evaporator 21 in an inner part of the air-conditioning system 20, heated by means of the heating apparatus 6 further, when necessary and supplied to the in-car space 2 via the blowing-out duct 10. On the other hand, the cooling medium in the refrigeration cycle is cooled down when ambient air driven by means of the outdoor fan 8 passes through the condenser 23.

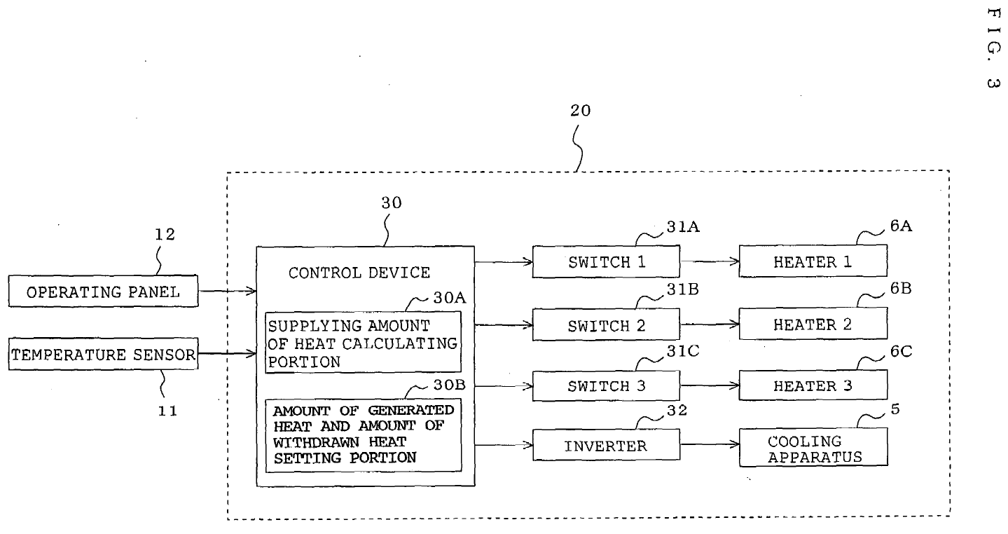

FIG. 3 is a block diagram showing a construction of the air-conditioning system 20 and ancillary equipment thereof. The air-conditioning system 20 is provided with the cooling apparatus 5 capable of changing the amount of withdrawn heat in a stepwise manner, and a plurality of heaters, 6A, 6B, and 6C having different heat release capabilities, which serve as heating elements constituting the heating apparatus capable of changing the amount of generated heat in the stepwise manner as explained earlier.

The cooling capability of the cooling apparatus 5 is enabled to be changed by controlling an operating frequency of the compressor 22 constituting the cooling apparatus 5 by means of an inverter 32. Here, the operating frequency of the cooling apparatus 5 is configured such that only three steps of, 40 Hz, 50 Hz, and 60 Hz are used because of restriction of a vibrating surface of the cooling medium circuit and circulation of lubricating oil, and respective cooling capabilities are configured to be −5 kW, −7 kW, and −9 kW. Incidentally, the operating frequency of the compressor 22 is not always restricted to these three of the number of the steps, or the values, and the same may also be appropriately changed within an area where safety is assured.

On the other hand, the heating apparatus 6 is constructed to be individually provided with three kinds of heaters 6A, 6B, and 6C having the different heat release capabilities that serve as the heating elements, and turning-on operation for each of the heaters 6A, 6B, and 6C is controlled by means of corresponding switches 31A, 31B, and 31C, respectively. The heat release capabilities of the respective heaters 6A, 6B, and 6C are 1 kW, 2 kW, and 4 kW, and the total heat release capability is therefore 7 kW here.

Incidentally, the number or the total capability of the heaters constituting the heating apparatus 6 is not limited to the aforementioned example. The number and the capabilities of the heaters can be configured such that the air-conditioning temperature can be more minutely set in a stepwise manner corresponding to the step-wise variation of the amount of withdrawn heat of the cooling apparatus 5. In addition, a heating element other than the heater is possible to be utilized.

In this example, heaters having heat release capabilities that can be set in even intervals between a heating capability generated by operation of one heater having minimum heat release capability and a heating capability generated by operation of all of a plurality of heaters, and also having heat release capabilities by which the cooling capabilities can be set in even intervals between a time of stopping of the compressor 22 and a time of operation of the compressor 22 at a maximum operating frequency, are selected and installed (refer to table 2 described later).

The air-conditioning system 20 is further provided with a control device 30 including a supplying amount of heat calculating portion 30A for calculating an amount of heat supplied to the in-car space 2, and an amount of generated and withdrawn heat setting portion 30B for setting the amount of heat of the cooling apparatus 5 and the heaters 6A, 6B, and 6C on the basis of the supplying amount of heat calculated by means of the supplying amount of heat calculating portion 30A.

The supplying amount of heat calculating portion 30A calculates the supplying amount of heat required for setting the temperature of the in-car space 2 to a target temperature on the basis of the temperature of the target value and a real temperature of the in-car space 2. This can be performed by means of, for example, a calculation of proportional-plus-integral (PI). In the calculation of the proportional-plus-integral (PI), an air-conditioning capability instruction value (or a supplying amount of heat instruction value) Q is calculated from a sum of: the product of deviation between the target temperature and the temperature of the in-car space 2, and a proportional gain; and the product of integral of the deviation over a time and an integration gain.

The amount of generated and withdrawn heat setting portion 30B sets operation of the cooling apparatus 5 and the heaters 6A, 6B, and 6C so that the supplying amount of heat calculated by means of the supplying amount of heat calculating portion 30A is obtained, and controls the switches 31A, 31B, and 31C and the inverter 32 corresponding thereto. Accordingly, the control device 30 is composed of a microcomputer, or the like where the aforementioned calculation and a control function are previously programmed.

Incidentally, as shown in FIG. 3, an operating panel 12 that serves as a target temperature setting device for setting a target value, and a temperature sensor 11 that serves as an in-car temperature detecting device for detecting a temperature of the in-car space 2 are respectively provided here, and these setting data and the detecting data are taken in to the control device 30 as input information.

The air-conditioning capability of the air-conditioning system 20 having the above described construction is shown in Table 1.

TABLE 1

| | | Air-conditioning |
|---|---|---|
| | Driving Device | Capability |
| Heating | Heater 6A is Turned On | +1 kW |
| Capability | Heater 6B is Turned On | +2 kW |
| | Heater 6C is Turned On | +4 kW |
| Cooling | Compressor is in Operation at 40 Hz | −5 kW |
| Capability | Compressor is in Operation at 50 Hz | −7 kW |
| | Compressor is in Operation at 60 Hz | −9 kW |

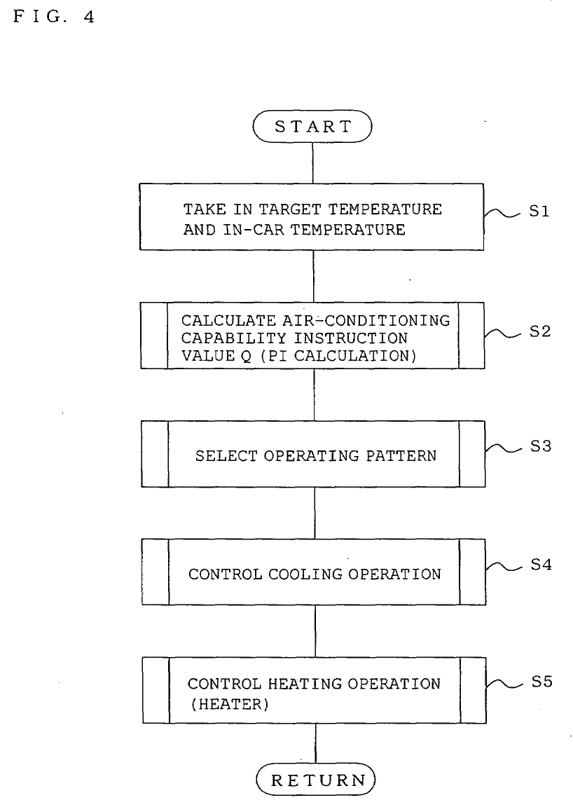

FIG. 4 is a flowchart showing a controlling content of the control device 30. Operation of the control device 30 will be explained referring to FIG. 4.

(Step S1) The target temperature of the in-car space 2 set by means of the operating panel 12, and a current value of the in-car temperature 2 detected by means of the temperature sensor 11 are inputted to the control device 30 of the air-conditioning system 20.
(Step S2) In the control device 30, the supplying amount of heat required for setting in-car space 2 to the target temperature is calculated at the supplying amount of heat calculating portion 30A on the basis of the value taken in Step S1. This calculation is performed by, for example, calculating the air-conditioning capability instruction value Q corresponding to the aforementioned supplying amount of heat, upon executing calculation of the proportional-plus-integral (PI) on the basis of the deviation between the target temperature and the real in-car temperature. Incidentally, the air-conditioning capability instruction value Q can also be calculated by a substitutive calculation of proportional integrodifferentiation (PID).
(Step S3) The control device 30 selects corresponding operating pattern from the operating patterns that are previously determined and memorized on the basis of the air-conditioning capability instruction value Q by combinations of the operating frequency of the cooling apparatus 5 and the heaters 6A, 6B, and 6C to be turned on. The operating pattern for the air-conditioning capability instruction value Q is configured to be determined, as shown in Table 2, for example.
(Steps S4 and S5) The control device 30 automatically adjusts the air-conditioning capability of the air-conditioning system 20 by means of controlling the operation of the cooling apparatus 5 and the heaters 6A, 6B, and 6C upon controlling the inverter 32 and the switches 31A, 31B, and 31C in accordance with the selected operating pattern.

TABLE 2

| Air-Conditioning | | Cooling | | | | | | | |
|---|---|---|---|---|---|---|---|---|---|
| Capability | | Apparatus | | | Heater (s) | | | | |
| Instruction | Operating | Operating | Cooling | | to be | Heating | | Air-Conditioning | |
| Value Q (kW) | pattern | Frequency | Capability | | Turned On | Capability | | Capability | |
| Q ≧ 7 | a | power off | 0 | kW | 6A + 6B + 6C | 7 | kW | 7 | kW |
| 7 > Q ≧ 6 | B | power off | 0 | kW | 6B + 6C | 6 | kW | 6 | kW |
| 6 > Q ≧ 5 | C | power off | 0 | kW | 6A + 6C | 5 | kW | 5 | kW |
| 5 > Q ≧ 4 | D | power off | 0 | kW | 6C | 4 | kW | 4 | kW |
| 4 > Q ≧ 3 | E | power off | 0 | kW | 6A + 6B | 3 | kW | 3 | kW |
| 3 > Q ≧ 2 | F | power off | 0 | kW | 6B | 2 | kW | 2 | kW |
| 2 > Q ≧ 1 | G | power off | 0 | kW | 6A | 1 | kW | 1 | kW |
| 1 > Q ≧ 0 | H | power off | 0 | kW | power off | 0 | kW | 0 | kW |
| 0 > Q ≧ −1 | I | 40 Hz | −5 | kW | 6C | 4 | kW | −1 | kW |
| −1 > Q ≧ −2 | J | 40 Hz | −5 | kW | 6A + 6B | 3 | kW | −2 | kW |
| −2 > Q ≧ −3 | K | 40 Hz | −5 | kW | 6B | 2 | kW | −3 | kW |
| −3 > Q ≧ −4 | L | 40 Hz | −5 | kW | 6A | 1 | kW | −4 | kW |
| −4 > Q ≧ −5 | M | 40 Hz | −5 | kW | power off | 0 | kW | −5 | kW |
| −5 > Q ≧ −6 | N | 50 Hz | −7 | kW | 6A | 1 | kW | −6 | kW |
| −6 > Q ≧ −7 | O | 50 Hz | −7 | kW | power off | 0 | kW | −7 | kW |
| −9 > Q ≧ −8 | P | 60 Hz | −9 | kW | 6A | 1 | kW | −8 | kW |
| −9 ≧ Q | Q | 60 Hz | −9 | kW | power off | 0 | kW | −9 | kW |

In this air-conditioning system 20, since the heating capability of the heaters 6A, 6B, and 6C are respectively set to 1 kW, 2 kW and 4 kw, the air-conditioning capability can be selected by every 1 kw intervals. In contrast, in a case that the heating apparatus 6 is constructed with three heaters of one kind having an amount of generated heat of, for example, 7 kW÷3=2.3 kW so as to satisfy the total heating capability of 7 kW of the heaters 6A, 6B and 6C, a minimum set interval of the air-conditioning capability reaches 2.3 kW and therefore, resolution (interval) of the air-conditioning capability becomes worse in comparison with the combinations shown in Table 2. Incidentally, although a concrete example of the construction of the air-conditioning system provided with three heaters is shown here, there is no need to make a limitation for the number of the heaters.

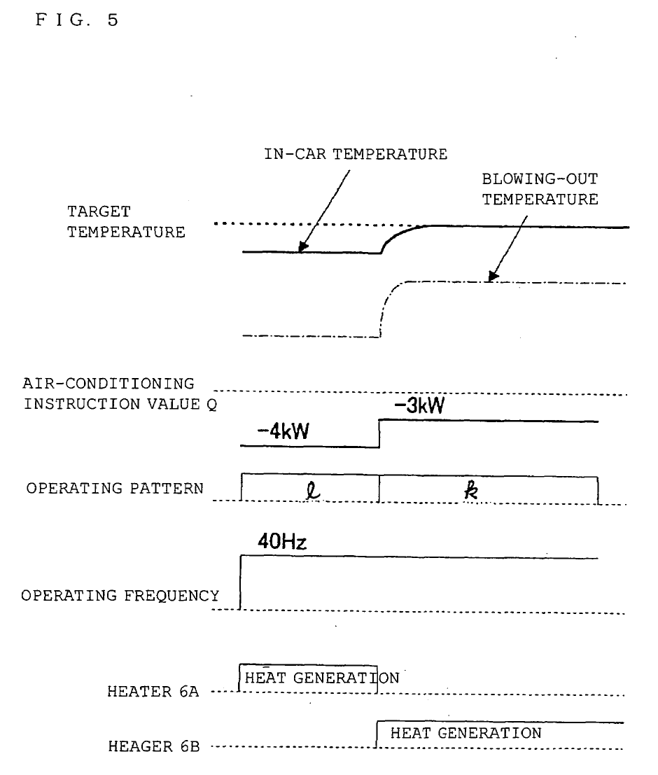

FIG. 5 is a timing chart showing operating timing of relevant portions when the air-conditioning capability instruction value Q is in transition from −4 kW to −3 kW in the air-conditioning system 20 constructed as described above.

When the air-conditioning capability instruction value Q is −4 kW, since the same is defined as, −3>Q≧14, the operating pattern “1” in Table 2 is selected. Next, in a case that the air-conditioning capability instruction value Q is increased and is resulted in −3 kW, the operating pattern “k” in Table 2 is selected because the same is defined as, −2>Q÷−3.

As explained above, in this air-conditioning system 20, the amount of generated heat of the heaters are selected in combination such that the obtained resolution (interval) of the air-conditioning capability can be made fine by means of combining the cooling capability and the heating capability. Thereby, a stable amount of heat can be constantly supplied to the in-car space 2 corresponding to the air-conditioning capability instruction Q by means of simple control of turning on and turning off operations of the heaters. In other words, since an optimal amount of heat (amount of withdrawn heat and generated heat) can be constantly supplied to the car interior while suppressing the temperature fluctuation of the blowing-out air, the temperature of the in-car space 2 can be stably controlled under a condition of small fluctuation.

In addition, according to the air-conditioning system 20 with respect to the present embodiment, since the air-conditioning capability can be finely controlled without performing the hitherto known turning-on rate control (turning-on time control), a frequency of the turning on and turning off operations of the switches for driving heaters can be reduced to a large extent, and product life duration of the switches can also be improved.

Incidentally, although an effect of the temperature fluctuation of the blowing-out air affecting the in-car temperature is different depending on a characteristic of a vehicle body (a heat capacity of the vehicle body, a heat release characteristic, or the like), the vehicle air-conditioning system of the present invention is appropriately used for the air conditioning for a narrow in-car space, such as a driver's seat, or the like, and for a case of a small heat capacity.

### REFERENCE NUMERALS

1 vehicle
2 in-car space
3 under floor space
4 above-the-roof space
5 cooling apparatus
6 heating apparatus
6A, 6B, and 6C heater
7 indoor fan
8 outdoor fan
9 return duct
10 blowing-put duct
11 temperature sensor
12 operating panel
20 air-conditioning system
21 evaporator
22 compressor
23 condenser
24 expansion valve
30 control device
30A supplying amount of heat calculating portion
30B amount of generated and withdrawn heat setting portion
31A, 31B, and 31C switch
32 inverter

1-6. (canceled)

7. A vehicle air-conditioning system, comprising:
a cooling apparatus including a refrigeration cycle having a compressor whose operating frequency is capable of being switched to a plurality of steps;
and a heating apparatus including a plurality of heating elements each having different heat release capability,
wherein an amount of heat to be supplied is configured to be capable of being changed in a stepwise manner by means of a selection and a combination of the plurality of steps of the operating frequencies of the compressor and the plurality of heating elements.

8. The vehicle air-conditioning system according to claim 7, wherein the plurality of heating elements has a heat release capability in which the heating capability can be set in even intervals between the heating capability generated by operation of one heating element having minimum heat release capability and the heating capability generated by operation of all of the plurality of heating elements, and wherein the plurality of heating elements has a heat release capability by which the amount to be supplied can be set in even intervals between the amount at a time of stopping of the compressor and the amount at a time of operation of the compressor at a maximum operating frequency.

9. The vehicle air-conditioning system according to claim 7, further having operating patterns being previously determined corresponding to the amount of heat to be supplied by the selection and the combination of an operating frequency of the compressor and the heating elements, wherein the air-conditioning system controls the cooling apparatus and the heating apparatus on the basis of the operating patterns.
